(19) United States
(12) Patent Application Publication
(10) Pub. No.: US 2011/0281712 A1
(43) Pub. Date: Nov. 17, 2011

(54) CENTRIFUGAL SEPARATOR

(75) Inventors: Guido Schlamann, Munster (DE); Frank Mendel, Drensteinfurt (DE); Martin Rölver, Havixbeck (DE); Harald Torno, Munster (DE)

(73) Assignee: HENGST GMBH & CO., KG, Muenster (DE)

(21) Appl. No.: 13/127,622

(22) PCT Filed: Nov. 5, 2009
(86) PCT No.: PCT/EP2009/007927

§ 371 Date: Jul. 26, 2011

(30) Foreign Application Priority Data
Nov. 6, 2008 (DE) 20 2008 014 734.4
Aug. 7, 2009 (DE) 10 2009 036 476.5

(51) Int. Cl. B04B 15/02; B04B 9/02; B04B 9/10

(52) U.S. Cl. 494/7; 494/14

(57) ABSTRACT

A centrifugal separator for separating oil mist out of the crankcase vent gas of an internal combustion engine or for separating solid contaminants out of the lubricant oil of an internal combustion engine, wherein the centrifugal separator has a rotationally drivable rotor, a housing which accommodates the rotor and a rotary drive for the rotor, wherein the rotary drive is an electric motor arranged within the housing. The centrifugal separator includes an arrangement for cooling the electric motor.

The present invention relates to a centrifugal separator for separating oil mist out from the crankcase vent gas of an internal combustion engine, or for separating solid contaminants out from the lubricant oil of an internal combustion engine, the centrifugal separator having a rotationally drivable rotor, a housing that accommodates the rotor, and a rotary drive for the rotor, the rotary drive being formed by an electric motor situated in the housing.

A centrifugal separator of the type named above is known for example from U.S. Pat. No. 7,396,373 B2. This known centrifugal separator is used to separate solid and/or liquid particles out from a gas stream. The separator has a rotor that is formed by a plate stack and is situated in a housing, and that can be set into rotation by an electric motor also situated in the housing. The gas stream that is to be cleaned enters the housing axially and flows through the rotor in the direction from radially inner to radially outer. The separated-out particles contact the inner surface of a circumferential wall of the housing of the centrifugal separator, and from there they are led downward by the action of gravity, to a separate outlet. The cleaned gas flows upward in the axial direction, to a cleaned gas outlet provided there. The electric motor that drives the rotor is also situated in the area of the housing through which the cleaned gas flow is conducted away.

In practice, in centrifugal separators of the type described above it has turned out to be a problem that the electric motor that drives the rotor tends to overheat, causing damages that impair the functional reliability of such a centrifugal separator.

The object of the present invention is therefore to create a centrifugal separator of the type named above that ensures long-lasting reliable operation.

This object is achieved according to the present invention by a centrifugal separator of the type named above, characterized in that it has means for cooling the electric motor.

The means provided according to the present invention for cooling the electric motor ensure that the electric motor in the housing of the centrifugal separator is always cooled sufficiently to avoid overheating and damage to the electric motor caused thereby. In this way, the electric motor achieves a lifespan sufficient for the time of use of the centrifugal separator, so that premature failure of the electric motor is no longer to be feared. At the same time, the cooling means make it possible to use an electric motor having a high specific output, enabling a small constructive size of the electric motor that drives the rotor.

The means for cooling the electric motor can be constructed in various ways, but are preferably realized in the embodiments described below.

A first embodiment proposes that at least one cooling element be provided as a means for cooling the electric motor. Such a cooling element is used in particular to provide an enlarged surface via which the electric motor can dissipate the heat arising therein. Moreover, due to its inherent heat capacity, a cooling element can absorb heat from the electric motor in order to conduct heat away from the electric motor before its temperature reaches a dangerous level. In addition, it is preferably provided that crankcase vent gas, or the cooling agent, or lubricant oil, or fuel, or cooling air of the internal combustion engine, or ambient air can flow over and/or can flow through the cooling element during operation of the centrifugal separator. In this way, the cooling element is actively cooled, further increasing the cooling effect of the cooling element on the electric motor.

In order to enable the heat arising in the electric motor to be dissipated via a path having the least possible resistance, a further embodiment of the present invention proposes that the cooling element be connected to a support element of the electric motor, or that it form such a support element.

Alternatively, the cooling element can be connected to an armature of the electric motor or can form this armature; this also achieves an effective heat dissipation from the electric motor, in particular from its armature. Here, the dissipation of heat from the cooling element is effectively supported by its rotation.

A further embodiment of the centrifugal separator provides that the rotor has a bearer part that is connected in rotationally fixed fashion to the armature of the electric motor and has a separator part connected in rotationally fixed fashion to the bearer part, and that the bearer part is fashioned as a cooling element that stands in thermally conductive contact with the armature of the electric motor. This embodiment unites two functions in one component, because here the bearer part acts both as a bearer for the separator part of the rotor and as a cooling element. This contributes significantly to a simple and compact construction of the centrifugal separator.

In order to achieve effective heat dissipation, the cooling element preferably has a plurality of wings. The wings offer a large surface via which heat can be dissipated, for example to the medium to be cleaned that flows through the centrifugal separator.

In a further development, it is provided that the cooling element is rotationally symmetrical, and that the wings are oriented radially and are distributed around the circumference of the cooling element. In this way, the cooling element is suitable for high rotational speeds. In addition, the wings are situated in a high-speed region, which promotes the heat dissipation.

In addition, for reasons of good heat dissipation and sufficient strength during the rotation of the cooling element, it is provided that this element has a radially internal sleeve-shaped area that is situated on the outer circumference of the armature of the electric motor and from which the wings extend. This achieves a particularly intensive cooling of the electric motor in its embodiment having an external armature. At the same time, this makes the cooling element very stable internally.

Also for reasons of stability and reasons of good heat conductivity, the cooling element is preferably a one-piece metal part, preferably a die-cast part made of light metal, in particular aluminum or magnesium.

In particular for reasons of cost and weight, the housing is preferably a one-piece plastic part, preferably an injection-molded part made of a thermoplastic, in particular polyamide.

If a further increase of the cooling effect is desired or required, it is possible to provide at least one cooling agent duct as a means for cooling the electric motor. The cooling agent duct creates the possibility of conducting a cooling agent in the housing through or over parts that are to be cooled in a targeted manner, or to use a separate cooling agent to cool the electric motor. In both cases, a stronger cooling effect can be achieved.

In a further embodiment, the cooling agent duct can run through the support element and/or over at least one surface of the support element of the electric motor.

Alternatively or in addition, it is possible for the cooling agent duct to run through a part of the housing that bears the support element of the electric motor. In this case, the heat is then first conducted from the support element into the part of the housing that bears said element, from where an effective dissipation of heat then takes place through the cooling agent duct.

In addition, in this regard it is provided that in the housing there is provided an axle that is connected to the housing or that is realized in one piece, forming the part of the housing that bears the support element of the electric motor and through which the cooling element duct runs. In this embodiment, the axle required for the mounting of the rotor is simultaneously used to conduct the cooling agent, further contributing to a simple construction and compact design.

In a further embodiment, it is proposed that the bearer part be mounted on the axle with the interposition of at least two bearings, preferably roller bearings, situated at a distance from one another in the longitudinal direction of the axle. In this way, the bearer part is mounted on the axle so as to move freely, so that with low drive power the rotor achieves high rotational speeds in order to achieve an effective centrifugal separation.

In addition, it is preferably provided that cooling water or lubricant oil or fuel or compressed air from the internal combustion engine can be guided through the cooling agent duct. Cooling water is a medium that is well-suited for carrying heat away from the electric motor, and is available in every water-cooled internal combustion engine. In terms of quantity, the cooling water that flows through the cooling agent duct makes up only a very small part of the cooling water stream circulating in a cooling system, so that the cooling of the electric motor of the centrifugal separator can be achieved without additional outlay of cooling capacity of the actual cooling circuit of the internal combustion engine. Alternatively, the lubricant oil or the fuel of the internal combustion engine can be conducted through the cooling agent duct in order to cool the electric motor, because these liquids are also available in an internal combustion engine. If present in a motor vehicle equipped with an internal combustion engine having a centrifugal separator, compressed air of an associated compressed air braking system can also be conducted through the cooling agent duct in order to cool the electric motor.

A preferred embodiment of the present invention provides that the electric motor has as a support element a system of coils that surrounds a segment of the axle and is mounted on the axle, and has as an armature a magnetic sleeve that radially surrounds the system of coils externally with an annular gap for movement, said sleeve being mounted on the bearer part. The magnetic sleeve can easily be manufactured with a smooth cylindrical outer surface, making the connection of the magnetic sleeve to the bearer part particularly simple and ensuring good heat transfer.

In addition, it is preferably provided that the bearer part has, in the area of an end face of the armature and support element, a plurality of additional wings extending over the annular movement gap. With these additional wings, a ventilation of the annular movement gap can be carried out that also ensures a cooling of the coil system situated inside the magnetic sleeve.

If the cooling of the electric motor is accomplished using gas flowing through the centrifugal separator, in order to avoid a disturbing contamination of the electric motor the motor is usefully situated at a cleaned gas side of the centrifugal separator.

In order to provide easy installation of the centrifugal separator, and for thermal reasons, the electric motor is preferably situated at an externally accessible upper side of the centrifugal separator, said upper side being situated outside the associated internal combustion engine in the installed state.

Here it is preferably further provided that the cooling element is realized as a cover that forms the upper side of the centrifugal separator. The cooling element is thus situated outside the internal combustion engine, and can be effectively cooled there for example by the airstream during travel, or by ventilated cooling air.

A further proposal provides that the cover accommodates or contains an electronics unit belonging to the electric motor. In this embodiment, heat loss from the electronics unit can also be dissipated via the cover.

In order to prevent heat from the electric motor from overheating the electronics unit, or to prevent heat from the electronics unit from overheating the electric motor, it is proposed that the cover be divided into two parts that are thermally insulated from one another, and that a first cover part stand in thermally conductive connection with the electric motor, and a second cover part stand in thermally conductive connection with the electronics unit.

An even better thermal separation can be achieved if the electric motor and electronics unit are separated from one another by a thermal insulating element.

If the ambient air or cooling air is not sufficient for the cooling, according to a further proposal an attachment having an inlet and outlet for a cooling fluid that flows over the cover can be connectable to, or connected to, the cover.

An embodiment of the present invention provides that the housing has a lower part having an inlet for a raw medium that is to be supplied to the rotor and an outlet for medium separated from the raw medium, the lower part being producible as a separate individual part and connectable, preferably by welding or plugging, to the rest of the housing in various rotational positions relative thereto. This enables, in a simple manner, the flexible adaptation of the separator to various situations of installation.

In order to prevent liquid from collecting in the raw medium inlet in a way that would bring about long-term damage to the functioning of the separator, it is provided that the housing has a lower part having an inlet for the raw medium that is to be supplied to the rotor and having an outlet for medium separated out from the raw medium, and that a connecting duct be provided between an area of the inlet that is the lowest-situated area in the installed state and the outlet, said connecting duct being fashioned as, or so as to have, a throttle, and not rising toward the outlet. Through this connecting duct, liquid that has already precipitated out and collected in the raw medium inlet can be guided to the outlet without the use of further auxiliary devices, and thus conducted away.

In modern internal combustion engines, a modular design is increasingly sought, and for this reason it is proposed that the housing be realized without a lower part and that it be capable of being plugged or screwed into a modular base, in particular of an oil filter module, so as to be sealed by seals, or into a cylinder head cover of the internal combustion engine.

However, the centrifugal separator can also be realized as a stand-alone auxiliary aggregate of an internal combustion engine and can be connectable to the internal combustion engine in itself. For this purpose, the centrifugal separator is usefully equipped with a connecting flange with which it can be flange-mounted on a module base, in particular of an oil filter module, or on a cylinder head cover of the internal combustion engine, such that a part of, or all, required flow connections from and to the internal combustion engine run through the connecting flange. Instead of being connected immediately to the internal combustion engine, the centrifugal separator can also be connected via the connecting flange to a functional module of the internal combustion engine, the functional module then being connectable to the internal combustion engine.

Because the electric motor has to be supplied with electrical energy in order to drive the rotor, it is further proposed that an electrical connection for supplying power to the electric motor be simultaneously producible via the connecting flange. This facilitates installation and offers a high degree of electrical functional reliability, because separate routing and connection of external power lines is then omitted.

Because during operation of an internal combustion engine the volume flow of the crankcase vent gas changes as a function of the load and rotational speed, it is proposed that the rotational speed of the electric motor that drives the rotor be modifiable in accordance with the volume flow of the crankcase vent gas. The performance of the separator can in this way be adapted to momentary requirements, which reduces energy consumption and wear on the separator.

In order to prevent tension in the bearing of the rotor on the one hand and unfavorable axial forces on the electric motor on the other hand, it is provided that the one bearer is seated on the axle in axially displaceable fashion as a movable bearing, that the other bearing is seated on the axle in axially non-displaceable fashion as a fixed bearing, and that a pressure spring is situated between the bearings. The spring provides compensation of thermally caused dimensional changes.

In addition, according to the present invention it is proposed for the centrifugal separator that the electric motor and the bearer part be permanent components of the centrifugal separator, and that the separator part be an exchangeable maintenance part of the centrifugal separator. In this way, a high-quality centrifugal separator is provided in which essential parts are permanent components, so that an unnecessarily large number of disposable parts is avoided. Only the separator part is still present as an exchangeable maintenance part of the centrifugal separator that can be replaced as needed in the context of regular maintenance.

Finally, it is provided that at least one liquid conducting channel is situated on an inner circumferential surface of the housing, surrounding the rotor, said channel running downward with a helical shape, seen in the direction of rotation of the rotor, and being downwardly open. When a gas cleaning takes place, this liquid conducting channel accommodates the liquid deposited on the inner circumferential surface of the housing and conducts it, supported by the rotation of the rotor and the gas flow produced thereby, downward along the helical line, from where the liquid can be conducted out from the separator. In this way, a high degree of security is achieved against entrainment of liquid already deposited on the inner circumferential surface of the housing into the cleaned gas stream.

In the following, exemplary embodiments of the present invention are explained on the basis of a drawing.

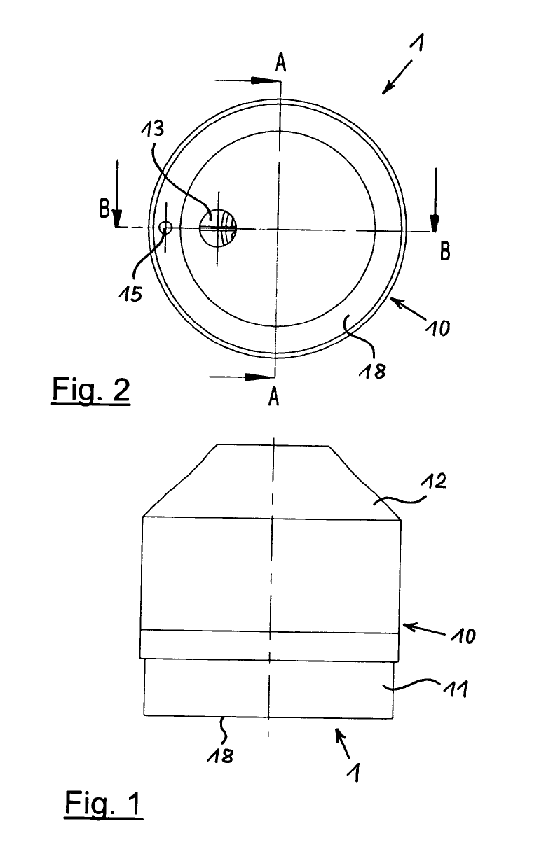

FIG. 1 shows a first centrifugal separator in a side view,

FIG. 2 shows the centrifugal separator from FIG. 1 in a view from below,

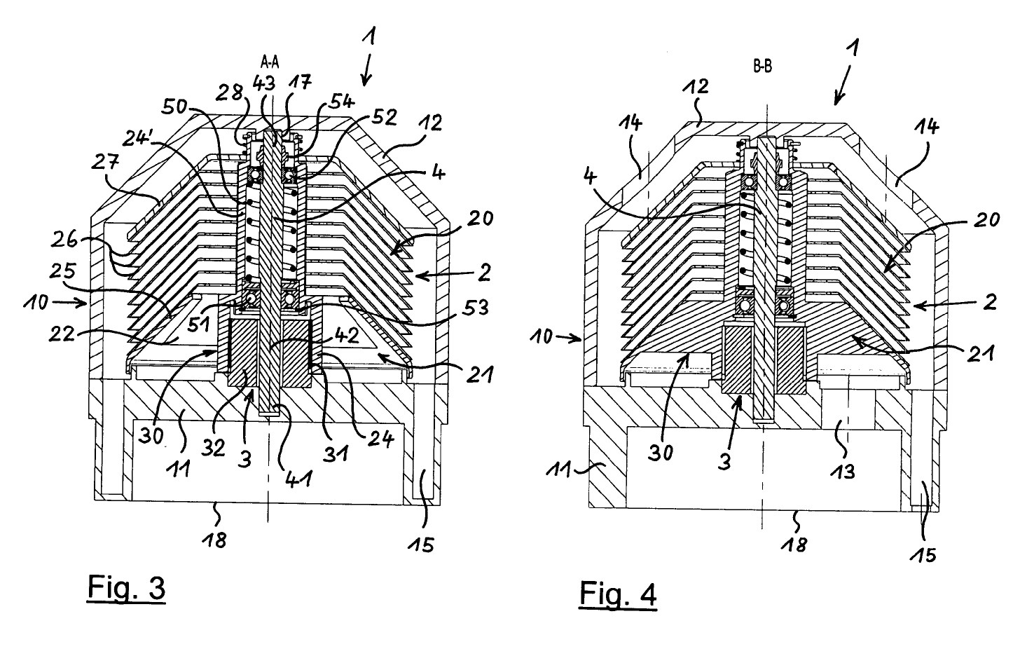

FIG. 3 shows the centrifugal separator from FIGS. 1 and 2 in a longitudinal section along the sectional line A-A in FIG. 2,

FIG. 4 shows the centrifugal separator from FIGS. 1 and 2 in a longitudinal section along the sectional line B-B in FIG. 2,

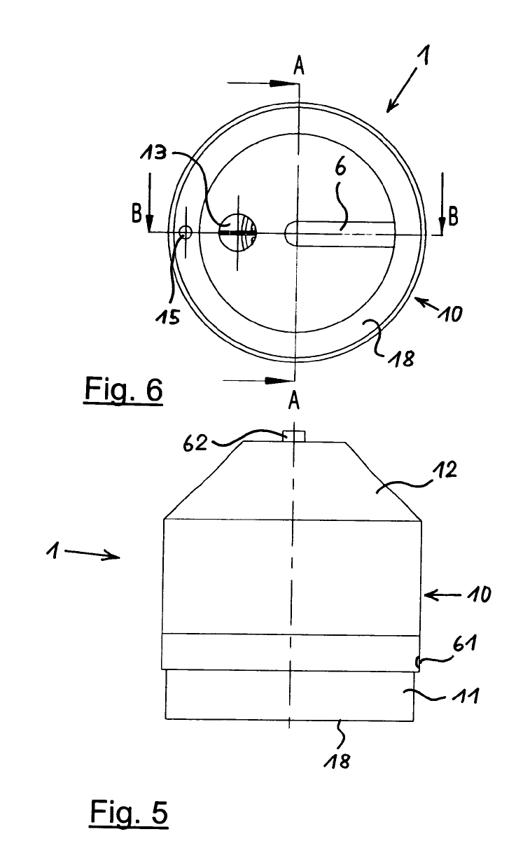

FIG. 5 shows a second centrifugal separator in an external view,

FIG. 6 shows the centrifugal separator from FIG. 5 in a view from below,

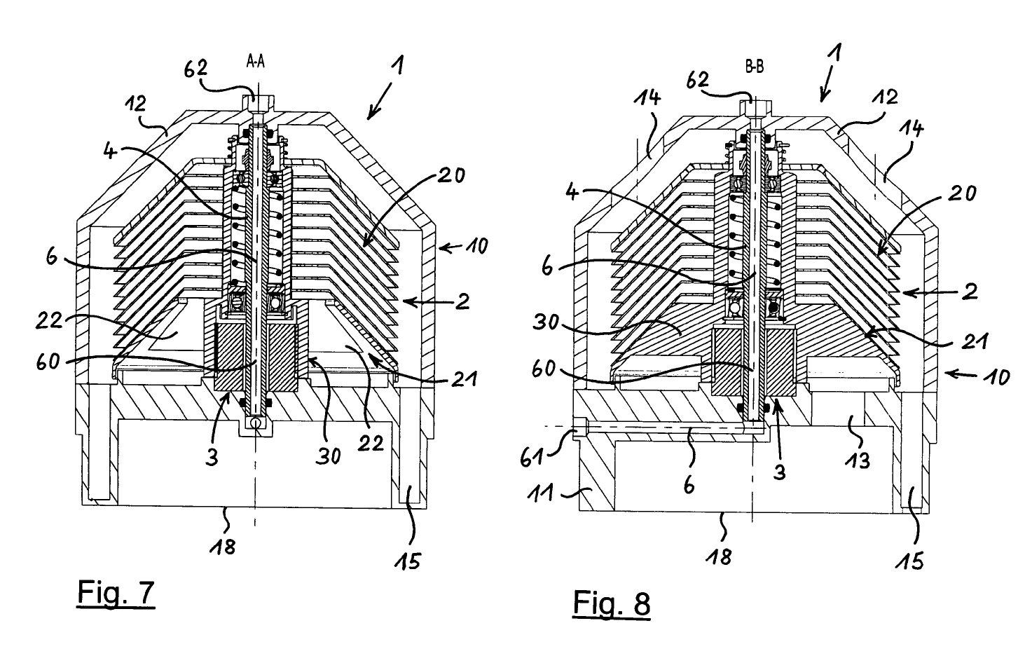

FIG. 7 shows the centrifugal separator from FIGS. 5 and 6 in a longitudinal section along sectional line A-A in FIG. 6,

FIG. 8 shows the centrifugal separator from FIGS. 5 and 6 in a longitudinal section along sectional line B-B in FIG. 6,

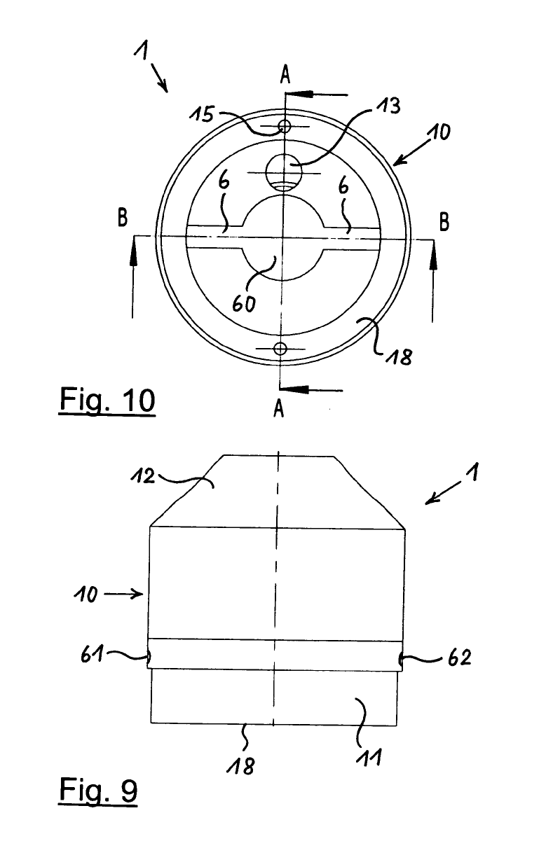

FIG. 9 shows a third centrifugal separator in a side view,

FIG. 10 shows the centrifugal separator from FIG. 9 in a view from below,

FIG. 11 shows the centrifugal separator from FIGS. 9 and 10 in longitudinal section along sectional line A-A in FIG. 10,

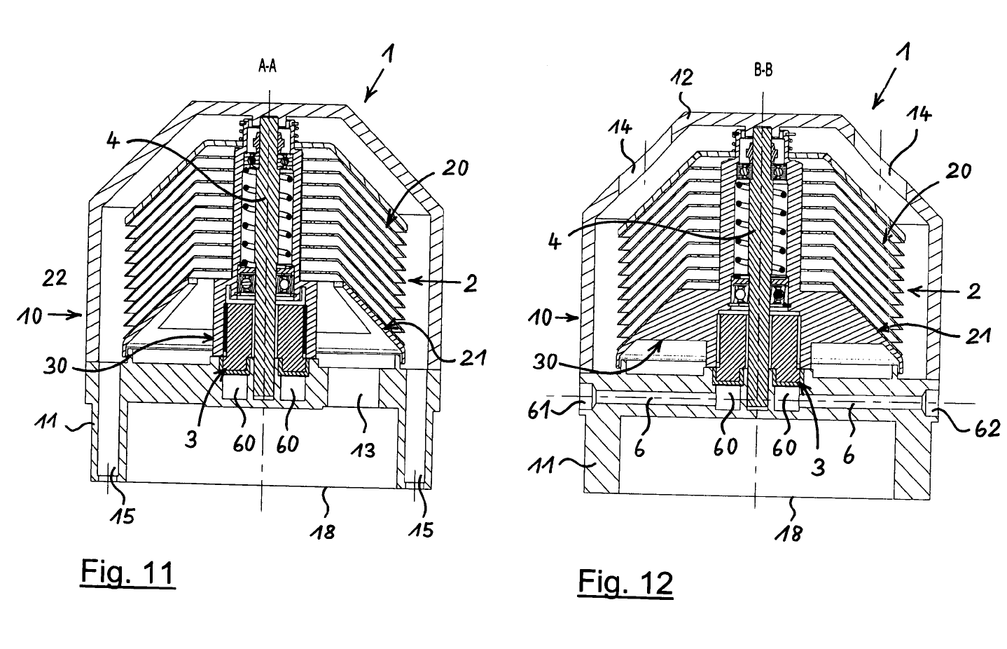

FIG. 12 shows the centrifugal separator from FIGS. 9 and 10 in a longitudinal section along sectional line B-B in FIG. 10,

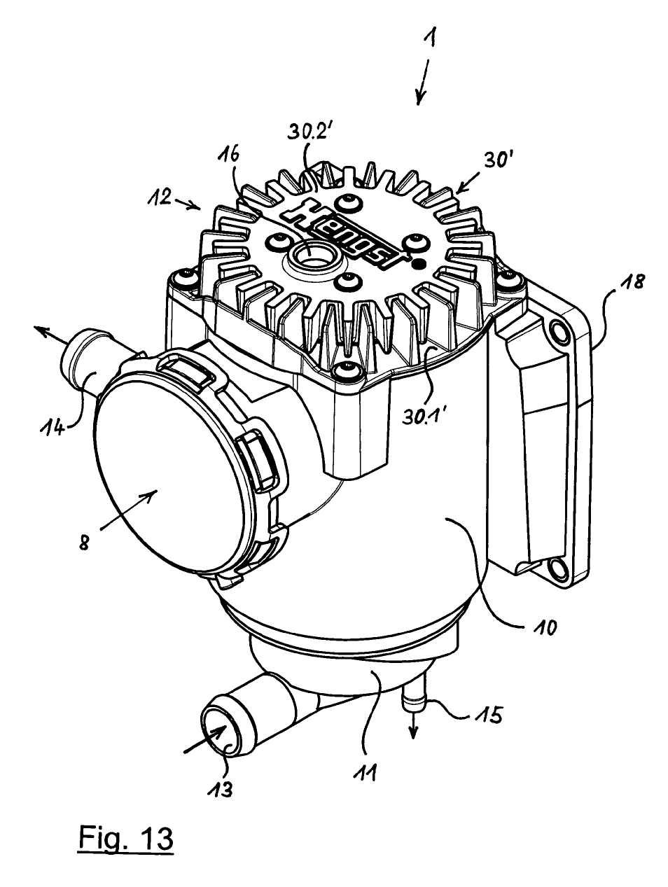

FIG. 13 shows a fourth centrifugal separator in a perspective view,

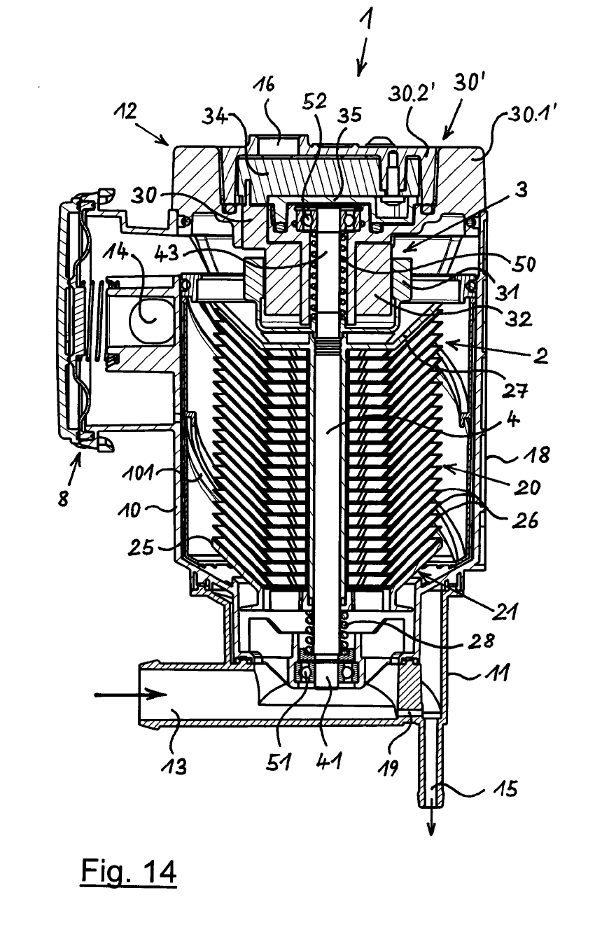

FIG. 14 shows the centrifugal separator from FIG. 13 in a first longitudinal section,

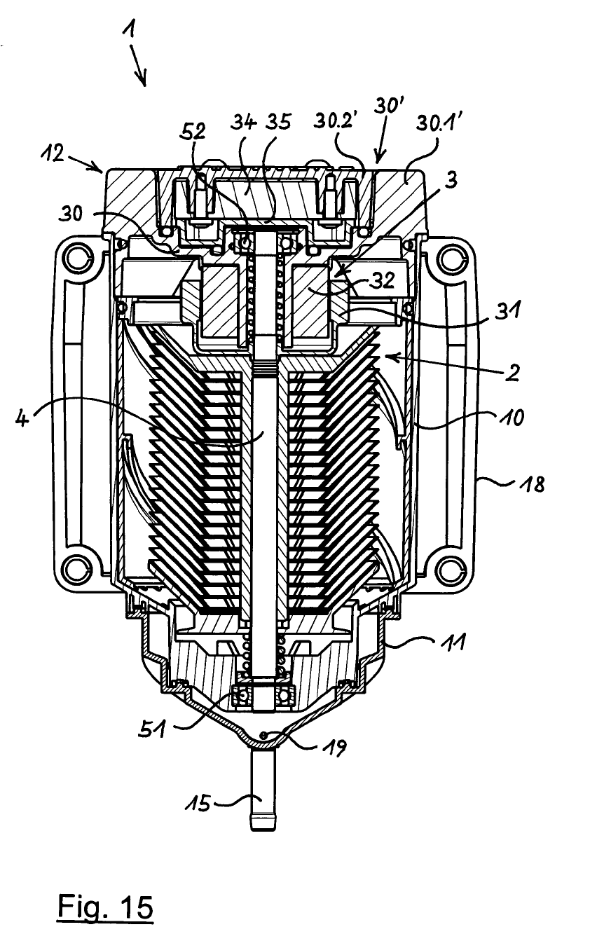

FIG. 15 shows the centrifugal separator from FIGS. 13 and 14 in a second longitudinal section, rotated by 90°, and

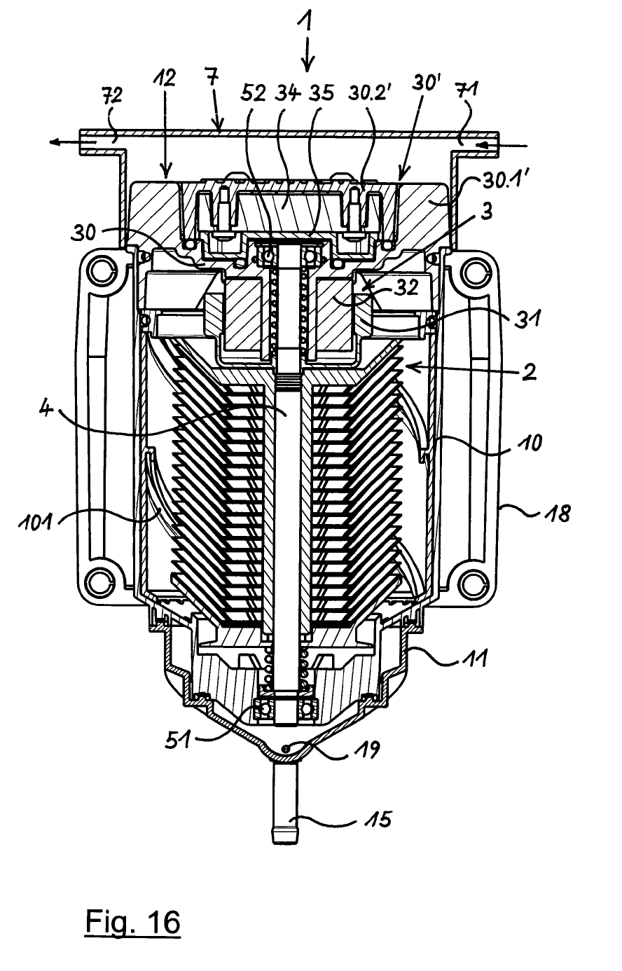

FIG. 16 shows a fifth centrifugal separator in a longitudinal section.

FIG. 1 shows a first centrifugal separator 1 in a side view; a housing 10 of separator 1 is visible that comprises an essentially cylindrical lower part 11 and a cover 12 whose basic shape is also cylindrical and that has the shape of a truncated cone in its upper part. The lower side of lower part 11 forms a connecting flange 18 with which centrifugal separator 1 can be connected to an associated internal combustion engine (not shown here) or to a functional module that is part of the internal combustion engine.

FIG. 2 shows centrifugal separator 1 from FIG. 1 in a view from below. Connecting flange 18 is situated radially outwardly on the visible side of housing 10; in this flange, at the left in FIG. 2 an outlet 15 is visible for medium separated out in centrifugal separator 1, e.g. lubricant oil from the crankcase vent gas of an internal combustion engine. Radially inwardly offset from outlet 15, there is situated an inlet 13 for the raw medium that is to be cleaned in centrifugal separator 1, e.g. the crankcase vent gas of the associated internal combustion engine. If centrifugal separator 1 is flange-mounted on the internal combustion engine or on a functional module of the internal combustion engine, inlet 13 for the raw medium is then connected in terms of flow to the crankcase of the internal combustion engine; outlet 15 is then for example connected to an oil sump of the internal combustion engine.

The inner construction of centrifugal separator 1 is illustrated on the basis of the longitudinal sections shown in FIGS. 3 and 4 of centrifugal separator 1, along sectional lines A-A and B-B in FIG. 2. Inside housing 10, a rotor 2 is mounted on an axle 4 with the aid of two bearings 51, 52. Rotor 2 comprises a separator part 20 and a bearer part 21. Separator part 20 is made up of a plate stack 26 having a known design, plate stack 26 being seated on a plate support 25 and covered at the top by a covering plate 27. The arrangement made up of plate support 25, plate stack 26, and covering plate 27 is pressed together by a helical spring 28, so that the overall system assumes a stable position. Bearer part 21 has an upward-protruding sleeve-shaped segment 24′ on which separator part 20 is placed from above and secured so as to be rotationally fixed.

Here, electric motor 3 situated under rotor 2 is used to drive rotor 2. Electric motor 3 has a support element 32, for example an electromagnetic coil arrangement, surrounding lower segment 42 of axle 4. An armature 31, formed for example by a magnetic sleeve, is situated so as to surround support element 32. Armature 31 is connected in rotationally fixed fashion to a sleeve-shaped segment 24 of bearer part 21 of rotor 2. When electric motor 3 is supplied with electrical energy, in this way rotor 2 is set into the rotation around axle 4 required for its function.

In order to dissipate the heat that arises in electric motor 3 during its operation, and to avoid overheating and damage to electric motor 3, bearer part 21 of rotor 2 is here simultaneously fashioned as cooling element 30 for electric motor 3. For this purpose, bearer part 21 has, in addition to sleeve-shaped segment 24 standing in immediate thermally conductive contact with electric motor 3, a plurality of wings 22 situated at a distance from one another in the circumferential direction, which enlarge the surface of bearer part 21 and thus form an effective cooling element 30. During rotation of rotor 2, the medium that is to be cleaned and that flows through centrifugal separator 1 flows over cooling element 30, causing the heat emitted by electric motor 3 to be transported away from the electric motor and transferred to the medium flowing through centrifugal separator 1.

Lower end 41 of axle 4 is connected in fixed position to lower part 11 of housing 10. Upper end 43 of axle 4 is centered in a centering receptacle 17 on the underside of cover 12.

Using a helical pressure spring 50 situated between bearings 51 and 52, play in the longitudinal direction between bearings 51, 52 is compensated; here, the one bearing 51 is a movable bearing and the other bearing 52 is a fixed bearing. Lower bearing 51 is limited in its axial downward mobility by a retaining ring 53 situated under it and connected to axle 4. Above upper bearing 52, a securing sleeve 52 is attached on upper area 43 of axle 4.

Inlet 13 in the upper area of lower part 11, visible in FIG. 4, is used to supply the medium that is to be cleaned in centrifugal separator 1, such as crankcase vent gas; the medium flows through this inlet into the inner space of cover 12 at the lower side of rotor 2. From there, the medium to be cleaned flows upward in the axial direction in the rotor in a known manner, and is thus distributed to the intermediate spaces between the plates of plate stack 26. Through rotating separator part 20, the medium to be cleaned moves outward in the radial direction, and centrifugal forces that arise here cause liquid and/or solid particles to be removed from the medium. The cleaned medium then flows radially outward from rotor 2 upward and leaves centrifugal separator 1 through outlets 14, visible in FIG. 4, in cover 12. Under the influence of gravity, the separated particles move into outlet 15 and are led away from there, for example as separated lubricant oil, into the oil sump of an associated internal combustion engine, to which centrifugal separator 1 is connectable or is connected by connecting flange 18.

FIG. 5 shows a side view of a second centrifugal separator 1. In its external shape, centrifugal separator 1 essentially corresponds to the example shown in FIG. 1. In the separator 1 shown in FIG. 5, the difference is that here a separate cooling agent can be routed through centrifugal separator 1. For this purpose, according to FIG. 5 a cooling agent duct connection 61 is fashioned in lower part 11, on the right side. This connection 61 is connected to a cooling agent duct that is not shown in FIG. 5 and that runs in the interior of centrifugal separator 1. The other end of the cooling agent duct opens into a second cooling agent duct connection 62, here fashioned in the center of the upper side of cover 12. Via connections 61 and 62, by means of conduits that are not shown a separate cooling agent can be supplied and carried away, e.g. cooling water or lubricant oil or fuel from the associated internal combustion engine.

Connecting flange 18 is again provided on the lower side of housing 10, or lower part 11 thereof.

In the lower view shown in FIG. 6 of centrifugal separator 1 from FIG. 5, the positions of inlet 13 for the raw medium and of outlet 15 for the separated medium are visible. At the right of raw medium inlet 13, here the route of a segment of cooling agent duct 6 is visible, which is used for active cooling of the electric motor of centrifugal separator 1, as is illustrated more clearly in FIGS. 7 and 8.

FIGS. 7 and 8 show the centrifugal separator of FIGS. 5 and 6 in two longitudinal sections. Rotor 2 inside housing 10 corresponds that of centrifugal separator 1 as shown in FIGS. 1 through 4; reference is made to the description thereof.

In centrifugal separator 1 according to FIGS. 5 through 8, cooling agent duct 6 differs from that shown in the previously described exemplary embodiment. As FIG. 8 shows, cooling agent duct 6 begins at cooling agent duct connection 61, situated radially externally on lower part 11 of housing 10, and from there runs first radially inward up to the center of lower part 11. There, cooling agent duct 6 meets axle 4, here realized as a hollow axle, so that as it continues cooling agent duct 6 runs axially upward through axle 4. Second cooling agent duct connection 62, through which the cooling agent can be carried away, is situated in the center of cover 12. A segment of cooling agent duct 6 that runs centrally in axle 4 through electric motor 3 forms a cooling zone 60, in which heat from electric motor 3 can be emitted to the cooling agent flowing through cooling agent duct 6 and then carried away with this agent. The direction of flow of the cooling agent in cooling agent duct 6 can of course also run in the opposite direction.

In its further individual parts, centrifugal separator 1 according to FIGS. 5 through 8 corresponds to the first exemplary embodiment shown in FIGS. 1 through 4; reference is made to the description thereof.

FIG. 9 shows a third exemplary embodiment of centrifugal separator 1 in a side view. The basic shape of centrifugal separator 1 according to FIG. 9 again corresponds to that of the exemplary embodiments according to FIGS. 1 and 5.

In centrifugal separator 1 according to FIG. 9 as well, a cooling agent duct is provided in the interior of the separator. The two cooling agent duct connections 61 and 62, for supplying and carrying away cooling agent, are here situated diametrally opposite one another on lower part 11, in the circumferential surface thereof.

The view from below shown in FIG. 10 shows the positions of inlet 13 for the raw medium and of outlet 15 for the separated medium in separator 1 according to FIG. 9. In addition, FIG. 10 shows the routing of cooling agent duct 6; central cooling zone 60 is visible, seen here in the radial direction.

The lower side of housing 10 also here again forms connecting flange 18 for connecting centrifugal separator 1 to an associated internal combustion engine or to a functional module of the internal combustion engine.

The two longitudinal sections along sectional lines A-A and B-B in FIG. 10 are shown in FIGS. 11 and 12. In this third exemplary embodiment as well, rotor 2 of centrifugal separator 1 is realized so as to agree with rotors 2 of the two previously described exemplary embodiments; reference is made to the previous description thereof.

In FIG. 11, inlet 13 is visible for supplying the raw medium to be cleaned to rotor 2. Outlet 15 for the separated medium is visible radially externally in lower part 11. The underside of lower part 11 again forms connecting flange 18.

FIG. 12 shows the path of cooling agent duct 6 through lower part 11 of housing 10. Cooling agent duct connection 61 for supplying the cooling agent is situated at left on lower part 11, on the circumferential surface thereof. From there, cooling agent duct 6 leads inward in the radial direction, where it opens into an annular cooling zone 60. Second cooling agent duct connection 62 is situated on the opposite side of lower part 11, said connection being connected to a second segment of cooling agent duct 6 that runs radially outward from cooling zone 60, and acting to carry away the cooling agent.

Annular cooling zone 60 of cooling agent duct 6 runs underneath electric motor 3, and the cooling medium can thus effectively absorb heat from electric motor 3 and carry it away. In order to avoid damage to the electric motor by the cooling medium, of course a corresponding seal is provided here.

The two outlets 14 on the upper side of cover 12, visible in FIG. 12, are used to carry away the cleaned medium from centrifugal separator 1.

The other parts of centrifugal separator 1 correspond to the previously described exemplary embodiments; reference is made to the description thereof.

FIG. 13 shows, in a perspective view, a further centrifugal separator 1 provided in order to remove oil from crankcase vent gas of an internal combustion engine. A housing 10 of separator 1 is externally visible, and has an essentially cylindrical shape. Housing 10 is sealed at the bottom by a lower part 11. At the upper side, a cover 12 is seated on housing 10. On the side of housing 10 oriented toward the right in FIG. 13, a connecting flange 18 is integrally formed, by which centrifugal separator 1 is connectable to an associated internal combustion engine or to a functional module appertaining to the internal combustion engine (engine and module not shown).

On lower part 11, an inlet 13 for the raw medium is integrally formed, inlet 13 here being fashioned as a hose connecting piece that runs radially.

Pointing axially downward, an outlet 15 for separated medium is provided on lower part 11, outlet 15 here also being formed as a hose connecting piece.

On the circumference of housing 10, there is situated a pressure regulating valve 8 through which the gas cleaned in the separator flows to outlet 14 for the cleaned medium. Outlet 14 is also realized as a hose connecting piece. Pressure regulating valve 8 is used to regulate the pressure in the crankcase of the associated internal combustion engine.

Cover 12 is here fashioned as cooling cover 30′ and has for this purpose a plurality of cooling ribs or wings on its circumference. Cooling cover 30′ is divided into two cover parts 30.1′ and 30.2′ that are thermally separated from one another. The one cover part 30.1′ is connected in thermally conductive fashion to an electric motor cooling element (not shown) or some other heat-emitting part of an electric motor, situated in the upper area of the interior of housing 10. The other cover part 30.2′ is connected in thermally conductive fashion to an electronics unit (not shown) of the electric motor, also situated in the upper area of the interior of housing 10. In this way, here the electric motor and its electronics unit are cooled largely without mutual influence.

Finally, another electrical connection 16, e.g. a socket for a power supply cable of the electric motor, is provided in the upper side of cover 12 or 30′.

On the basis of the longitudinal sections shown in FIGS. 14 and 15 of centrifugal separator 1 according to FIG. 13, the inner structure of the separator can be seen. Inside housing 10, a rotor 2 having an axle 4 is rotatably mounted using two bearings 51, 52. Rotor 2 comprises a separator part 20 and a bearer part 21. Separator part 20 is made up of a plate stack 26 having a known construction, plate stack 26 being seated on a plate support 25 and being covered at the top by a cover plate 27. The arrangement made up of plate support 25, plate stack 26, and cover plate 27 is pressed together from below by a helical spring 28, so that the system assumes an internally stable configuration.

An electric motor 3 situated above rotor 2 is used here to drive rotor 2. Electric motor 3 has a support element 32, e.g. an electromagnetic coil arrangement, that surrounds upper segment 43 of axle 4. An armature 31, formed for example by a magnetic sleeve, is situated so as to surround support element 32. Armature 31 is here connected in rotationally fixed fashion to upper segment 43 of axle 4. When electric motor 3 is supplied with electric energy, in this way rotor 2, together with axle 4 mounted rotatably in bearings 51 and 52 in housing 10, is set into the rotation required for its function.

In order to dissipate the heat that arises in electric motor 3 during its operation, and to avoid overheating and damage to electric motor 3, here support element 32 of motor 3 is fashioned with a cooling element 30 for electric motor 3. Cooling element 30 stands in thermally conductive contact with cover part 30.1′ or is fashioned in one piece therewith. During operation of motor 3, the heat emitted by electric motor 3 is transported away from the motor by cooling element 30 and cover part 30.1′, and is transferred to the air surrounding or flowing over cover part 30.1′.

Above motor 3 there is situated electronics unit 34 thereof, which also produces heat losses during operation. Second cover part 30.2′ is used to dissipate this heat, said part forming a radially inner part of cooling cover 30′ and standing in thermally conductive contact with electronics unit 34.

Lower end 41 of axle 4 is rotatably mounted in lower bearing 51 in lower part 11 of housing 10. In its upper area 43, axle 4 is rotatably mounted in upper bearing 52. Using a helical pressure spring 50 situated under bearing 52, play in the longitudinal direction between bearings 51 and 52 is compensated, the one bearing here being a movable bearing and the other bearing being a fixed bearing.

The medium that is to be cleaned in centrifugal separator 1, such as crankcase vent gas of an internal combustion engine, is supplied via inlet 13 in lower part 11 (visible in FIG. 14), through which the medium moves into the interior of lower part 12 and to the underside of rotor 2. From there, the medium to be cleaned flows axially upward in rotor 2, and is distributed among the intermediate spaces between the plates of plate stack 26. Through rotating separator part 20, the medium to be cleaned moves outward in the radial direction, and the centrifugal forces that arise here cause liquid and/or solid particles to be removed from the medium. The cleaned medium then flows radially outward upward from rotor 2 and leaves centrifugal separator 1 through outlet 14 (visible in FIG. 14), which is situated in pressure regulating valve 8 attached laterally to housing 10. Under the influence of gravity, the separated particles move into outlet 15 and are carried away from there, for example being returned as separated lubricant oil to the oil sump of an associated internal combustion engine.

As already described, housing 10 has lower part 11 having inlet 13 for raw medium that is to be supplied to rotor 2, and having outlet 15 for medium separated out from the raw medium. Between an area of inlet 13 that is situated at the lowest position in the installed state and outlet 15, here there is provided a connecting duct 19 that is fashioned as, or so as to have, a throttle, and that does not rise to outlet 15. Connecting duct 19 is used to carry away liquids that already precipitate out in and collect in inlet 13 from a gas flowing to separator 1. Because connecting duct 19 has only a small cross-section, it does not disturb the flow of gas in separator 1.

In addition, on an inner circumferential surface of housing 10, surrounding rotor 2, there are situated a plurality of liquid conducting channels 101 that, seen in the direction of rotation of rotor 2, run helically downward and are downwardly open. Seen in cross-section, liquid conducting channels 101 are formed by L-profiles having limbs that first run radially inward and then run downward. During a gas cleaning, these liquid conducting channels 101 collect the liquid that is deposited on the inner circumferential surface of housing 10, and, supported by the force of gravity and by the rotation of rotor 2 and the rotating gas flow produced thereby, conduct it along the helical line downward, from where the liquid is conducted out from separator 10 through outlet 15.

Finally, FIG. 16 shows an embodiment of centrifugal separator 1 that corresponds essentially to the embodiment shown in FIGS. 13 through 15. The difference is that separator 1 according to FIG. 16 has in the area of its cooling cover 30′ an attachment 7 that is used for the cooling of cover parts 30.1′ and 30.2′ by a fluid cooling medium conducted through attachment 7. For this purpose, attachment 7 has on its one side an inlet 71 and, situated diametrally opposite, an outlet 72 for the fluid cooling medium. The cooling medium can be for example cooling water of the associated internal combustion engine, and attachment 7 can be inserted into the cooling water circuit via its inlet 71 and outlet 72, using connecting conduits.

In its further parts, centrifugal separator 1 according to FIG. 16 corresponds to the example shown in FIGS. 13 through 15; reference is accordingly made to the description thereof.

1-35. (canceled)

36. A centrifugal separator for separating oil mist out from the crankcase vent gas of an internal combustion engine, or for separating solid contaminants out from the lubricant oil of an internal combustion engine, the centrifugal separator having a rotationally drivable rotor, a housing that accommodates the rotor, and a rotary drive for the rotor, the rotary drive being formed by an electric motor that is situated in the housing, comprising the centrifugal separator having means for cooling the electric motor.

37. The centrifugal separator of claim 36, wherein at least one cooling element is provided as the means for cooling the electric motor.

38. The centrifugal separator of claim 37, wherein during operation of the centrifugal separator, the cooling element is arranged such that at least one of crankcase vent gas, a cooling agent, a lubricant oil, fuel, cooling air of the internal combustion engine, or ambient air, can flow over and/or can flow through the cooling element.

39. The centrifugal separator of claim 37, wherein the cooling element is connected to a support element of the electric motor, or forms this element.

40. The centrifugal separator of claim 37, wherein the cooling element is connected to an armature of the electric motor, or forms this armature.

41. The centrifugal separator of claim 40, wherein the rotor has a bearer part that is connected in rotationally fixed fashion to the armature of the electric motor and has a separator part that is connected in rotationally fixed fashion to the bearer part, and the bearer part is fashioned as a cooling element that stands in thermally conductive contact with the armature of the electric motor.

42. The centrifugal separator of claim 37, wherein the cooling element has a plurality of wings.

43. The centrifugal separator of claim 42, wherein the cooling element is rotationally symmetrical, and the wings are oriented radially and are distributed over the circumference of the cooling element.

44. The centrifugal separator of claim 43, wherein the cooling element has, radially inwardly, a sleeve-shaped area that is situated on the outer circumference of the armature of the electric motor and from which the wings extend.

45. The centrifugal separator of claim 37, wherein the cooling element is a one-piece metal part.

46. The centrifugal separator of claim 45, wherein the cooling element is a die-cast part made of light metal.

47. The centrifugal separator of claim 46, wherein the cooling element is made of one of aluminum or magnesium.

48. The centrifugal separator of claim 37, wherein the housing is a one-piece plastic part.

49. The centrifugal separator of claim 48, wherein the housing is an injection-molded part made of a thermoplastic.

50. The centrifugal separator of claim 49, wherein the housing is made of polyamide.

51. The centrifugal separator of claim 36, wherein at least one cooling agent duct is provided as the means for cooling the electric motor.

52. The centrifugal separator of claim 51, wherein the cooling agent duct runs through the support element and/or over at least one surface of the support element of the electric motor.

53. The centrifugal separator of claim 51, wherein the cooling agent duct runs through a part of the housing that bears the support element of the electric motor.

54. The centrifugal separator of claim 53, wherein at the housing there is situated an axle that is connected to the housing or is in one piece, and forms the part of the housing that bears the support element of the electric motor, and through which the cooling agent duct runs.

55. The centrifugal separator of claim 54, wherein the cooling agent duct is connected to an armature of the electric motor, or forms this armature, the rotor has a bearer part that is connected in rotationally fixed fashion to the armature of the electric motor and has a separator part that is connected in rotationally fixed fashion to the bearer part, and the bearer part is fashioned as a cooling element that stands in thermally conductive contact with the armature of the electric motor, and the bearer part is mounted on the axle intermediate the positioning of at least two bearings situated at a distance from one another in the longitudinal direction of the axle.

56. The centrifugal separator of claim 51, wherein cooling water, or lubricant oil, or fuel, or compressed air of the internal combustion engine, can be conveyed through the cooling agent duct.

57. The centrifugal separator of claim 54, wherein the electric motor has as a support element a coil arrangement that surrounds a segment of the axle and is mounted on the axle, and has as an armature a magnetic sleeve that radially externally surrounds the coil arrangement with an annular movement gap and is mounted on the bearer part.

58. The centrifugal separator of claim 57, wherein the bearer part has, in an end face region of the support element and the armature, a plurality of additional wings that extend over the annular movement gap.

59. The centrifugal separator of claim 36, wherein the electric motor is situated at a cleaned gas side of the centrifugal separator.

60. The centrifugal separator of claim 36, wherein the electric motor is situated at an upper side of the centrifugal separator that is externally accessible and, in the assembled state, is situated outside the associated internal combustion engine.

61. The centrifugal separator of claim 39, wherein the cooling element is realized as a cover that forms the upper side of the centrifugal separator.

62. The centrifugal separator of claim 61, wherein the cover accommodates or contains an electronics unit that belongs to the electric motor.

63. The centrifugal separator of claim 62, wherein the cover is divided into two cover parts that are thermally separated from one another, and a first cover part stands in thermally conductive connection with the electric motor, and a second cover part stands in thermally conductive connection with the electronics unit.

64. The centrifugal separator of claim 62, wherein the electric motor and the electronics unit are separated from one another by a thermal insulating element.

65. The centrifugal separator of claim 61, wherein connectable to or connected to the cover is an attachment having an inlet and an outlet for a cooling fluid that flows over the cover.

66. The centrifugal separator of claim 36, wherein the housing has a lower part having an inlet for raw medium that is to be supplied to the rotor, and having an outlet for medium separated out from the raw medium, the lower part being producible as a separate individual part and connectable to the rest of the housing in various rotational positions relative thereto.

67. The centrifugal separator of claim 66, wherein the lower part is connectable to the rest of the housing by one of welding or plugging.

68. The centrifugal separator of claim 36, wherein the housing has a lower part having an inlet for raw medium that is to be supplied to the rotor and having an outlet for medium separated out from the raw medium, and between an area of the inlet that is situated at the lowest point in the installed state and the outlet there is provided a connecting duct that is fashioned as, or so as to have, a throttle, and that does not rise to the outlet.

69. The centrifugal separator of claim 36, wherein the housing is realized without a lower part and can be plugged or screwed into a module base so as to be sealed by seals.

70. The centrifugal separator of claim 69, wherein the housing is plugged or screwed into the module base of an oil filter module.

71. The centrifugal separator of claim 69, wherein the housing is plugged or screwed into the cover cylinder head cover of the internal combustion engine.

72. The centrifugal separator of claim 36, wherein the centrifugal separator is equipped with a connecting flange with which it can be flange-mounted on a module base, with a part of, or all, required flow connections from and to the internal combustion engine running through the connecting flange.

73. The centrifugal separator of claim 72, wherein the module base is a part of one of an oil filter module or a cylinder head cover of the internal combustion engine.

74. The centrifugal separator as recited of claim 72, wherein at the same time an electrical connection for supplying power to the electric motor is producible via the connecting flange.

75. The centrifugal separator of claim 36, wherein a rotational speed of the electric motor that drives the rotor is modifiable in accordance with the volume flow of the crankcase vent gas.

76. The centrifugal separator of claim 55, wherein the one bearing is seated on the axle in axially displaceable fashion as a movable bearing, and that the other bearing is seated on the axle in axially non-displaceable fashion as a fixed bearing, and that a pressure spring is situated between the bearings.

77. The centrifugal separator of claim 41, wherein the electric motor and the bearer part are permanent components of the centrifugal separator, and the separator part is an exchangeable maintenance part of the centrifugal separator.

78. The centrifugal separator of claim 36, wherein at least one liquid conducting channel is situated on an inner circumferential surface, surrounding the rotor of the housing, said channel running downward with a helical shape, seen in the direction of rotation of the rotor, and being downwardly open.
